(19) United States
(12) Patent Application Publication
(10) Pub. No.: US 2011/0078234 A1
(43) Pub. Date: Mar. 31, 2011

(54) Active Bookmarks

(75) Inventor: Christof Engel, Rauenberg (DE)

(73) Assignee: SAP AG, Walldorf (DE)

(21) Appl. No.: 12/571,310

(22) Filed: Sep. 30, 2009

(51) Int. Cl. G06F 15/16

(52) U.S. Cl. 709/203

(57) ABSTRACT

This disclosure provides various embodiments for creating and using various types of active bookmarks. For example, an indication to initiate the creation of a client-side active bookmark at a first client is received. At least one server request sent from the first client to a server (or server application) is recorded and stored in a client-side active bookmark file. The at least one stored recorded server request included within the client-side active bookmark file is then executed at a second client. In a second example, a notification to initiate creation of a server-side active bookmark is received. Next, a set of information defining at least one client request associated with a server application is recorded in a server-side active bookmark file, the information capable of being used to display the final state of the server application. The server-side active bookmark file is then associated with a specific, addressable URL.

### TECHNICAL FIELD

This present disclosure relates to software and methods involving data management and, more particularly, to a system, software, and method for creating and using active bookmarks to allow users to access screens, pages, and information unavailable under current bookmark functionality.

### BACKGROUND

Browser and application bookmarks are used to remember the address of a particular web page, quickly access a particular web page, share a web page with friends, colleagues, and other users, and to feed search engine for gathering the content of certain pages. In general, bookmarks are entities that can be stored wherever a user prefers, such as on the user's computer desktop screen, in a favorites folder associated with a browser, or in removable media transferable from one system to another. Bookmark functionality is typically offered by a browser, not by an application running in the browser.

Each web page and web resource identifiable by a specific uniform resource locator (URL) can be bookmarked. While Hypertext Transfer Protocol (HTTP) pages are the most used example, various types of URLs are possible, including but not limited to “file:, “ftp:,” and “HTTPS” URLs. As an example, the result page of a search run on Google.com (http://www.google.com) can be used to create a bookmark. For instance, a user may enter the term “food” into the search box, initiate the search, and see a large list of hyperlinks returned by the search engine. Along with the results, an updated URL is also returned to the browser. A simplified example of the returned URL associated with the search could be “http://www.google.com/q=food.” As long as Google retains its URL parameter syntax, where the added parameter for a search term is listed as “q=<search term>,” a return to “http://www.google.com/q=food” will bring any user to the screen providing the search results in response to the search term of “food.” Thus, this URL, including the search parameter, can be used to create a browser-side bookmark that allows the user initiating the initial search, or anyone else accessing the same URL, to return to the search results. Using this knowledge, bookmarks associated with defined pages can be stored locally or shared with others to provide immediate access to a defined web page.

As web users and administrators have become more security conscious, many web-based applications have been designed to hide specific location and session-based information associated with internal screens of a particular application. For example, banking and other web applications involved with private information typically avoid using URL parameters, such that data necessary to move from an initial screen to a second screen does not become a part of the web applications URL. As one example, many secure sites use Hypertext Transfer Protocol Secure (HTTPS) connections without URL parameters, instead electing to encrypt context and user information inside HTTP requests sent between web pages at the web application server based on client interaction. These hidden interactions and transitions may commonly be used with a POST command, where all parameters become part of the encrypted body of the HTTPS request, and not as the URL itself. In these instances, the initial URL (i.e., www.bank.com) may stay the same throughout interactions with the web application, such that attempting to bookmark a specific page within the web application would result in a bookmark to the initial URL. Each time a user attempts to activate the bookmark associated with the specific page, the bookmark sends the user to the web application's initial page. While security is added by removing state, session, and use parameters from the URL, it comes at the expense of user convenience.

Additionally, as the amount of information needed to transition from one web page to another, or through multiple web or application pages, increases, length-limited URLs become unable to hold all of the information necessary to return the user to the exact location typically associated with a bookmark. In those instances, even if security allowed bookmarks to be created at internal sites within a web application, the URL's size limitation would prevent the recreation of the bookmarked location due to information lost during the URL's creation.

### SUMMARY

This disclosure provides various embodiments for creating and using various types of active bookmarks. For example, an indication to initiate the creation of a client-side active bookmark at a first client is received. At least one server request sent from the first client to a server (or server application) are recorded and stored in a client-side active bookmark file. The at least one stored recorded server requests included within the client-side active bookmark file are then executed at a second client. In a second example, a notification to initiate creation of a server-side active bookmark is received. Next, a set of information defining at least one client request associated with a server application are recorded in a server-side active bookmark file (or within an active bookmark database), the information capable of being used to display the final state of the server application. The server-side active bookmark file is then associated with a specific, addressable URL.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system for creating and using active bookmarks in accordance with one embodiment of the present disclosure.

FIG. 2A is a flowchart illustrating an example computer process for client-side creation of an active bookmark from the perspective of a client using an appropriate system, such as the system described in FIG. 1.

FIG. 2B is a flowchart illustrating an example computer process for client-side creation of an active bookmark from the perspective of a server using the same system of FIG. 2A.

FIG. 3A is a flowchart illustrating an example computer process for using an active bookmark created at the client from the client's perspective using an appropriate system, such as the system described in FIG. 1.

FIG. 3B is a flowchart illustrating an example computer process for using an active bookmark created at the client from the server's perspective using the same system of FIG. 3A.

FIG. 4A is a flowchart illustrating an example computer process for server-side creation of an active bookmark from the perspective of the client using an appropriate system, such as the system described in FIG. 1.

FIG. 4B is a flowchart illustrating an example computer process for server-side creation of an active bookmark from the server's perspective using the same system of FIG. 4A.

FIG. 5A is a flowchart illustrating an example computer process for using an active bookmark created at the server from the client's perspective using an appropriate system, such as the system described in FIG. 1.

FIG. 5B is a flowchart illustrating an example computer process for using an active bookmark created at the server from the server's perspective using the same system of FIG. 5A.

### DETAILED DESCRIPTION

This disclosure generally describes software, computer-implemented methods, and systems for creating and using active bookmarks associated with a web-based application. Active bookmarks can generally be understood as bookmarks to portions of websites, web applications, and other locations generally unable to be accessed using a traditional bookmark defined by a specific URL. Active bookmarks can be generated by recording and storing a series of interactions between a client and a server (e.g., between a client application and a server application) from the perspective of either the client or the server. More generally, client-side active bookmarks persist information that brings the client application from a first client state to a second client state, while server-side bookmarks persist information that bring the server application from a first server application state to a second server application state. In some instances, one or more actions associated with client-server application interactions may not result in communication to the server. In some examples, such actions may not be included within the active bookmarks. Instead, only the actions relevant to the change in client application and server application states may be identified as relevant and persisted within the active bookmark.

In a first example, client-side active bookmarks can be created by recording one or more requests sent by the client application to the server, including the set of relevant information associated with each particular request. In some instances, only request information sent to the server and resulting in a state change may be recorded. Generally, unless the server or the server application that is to interpret and act upon the request (such as a web application) has changed incompatibly (or such that the previous requests do not result in the same state changes) since the client-side active bookmark was created, the recorded client requests can be used to access or place the server application into the exact same state or session as the interaction instance associated with the creation of the client-side active bookmark. The client-side active bookmark may be stored as its own unique file type, and executed by different users or clients by exchanging specific client-side active bookmark files via known information sharing techniques, such as email or other suitable methods of file sharing. By providing a simple file, any user activating the client-side active bookmark may be provided with an instance of the associated client application displaying the server application's final state as defined by the instructions or interactions included in the client-side active bookmark.

In a second example, server-side active bookmarks can be created by recording one or more client requests received at a server (and associated with a server application), including one or more parameters or other information associated with the request, relevant to determine one or more state changes of the server application. Again, in some instances, only the requests (or portions of the requests) pertinent to a state change may be recorded and included in the server-side active bookmark. Once a certain set of requests is performed, the server application is placed into a defined state. By storing these client requests at the server, and associating a specific URL with the stored interactions in a server-side active bookmark, future requests targeted to the specific URL can instruct the server application to reenact the previous client requests and provide or present to the client requesting the specific URL the final screen generated by the interaction or series of interactions defined by the server-side active bookmark.

In general, both types of active bookmarks may be taken advantage of by any user associated with an instance of the client application related to the server application associated with the active bookmark. One benefit of such a technology is for server applications, websites, and other web-based applications that do not provide state-specific information inside a page's URL. In those instances, different users (or the same user who previously reached a certain location within the application) have not been able to directly access screens within the particular application. Using the recorded interactions of the client- or server-side active bookmarks, users may now reach internal screens or pages of an application without requiring the user to manually perform the identical steps necessary to reach the particular screen or location themselves. Instead, the described active bookmarks provide a tool or file that can be accessed similar to traditional bookmarks, but which allows access to pages previously unavailable to the users without significant manual input. These and additional advantages will be clear to one of skill in the art.

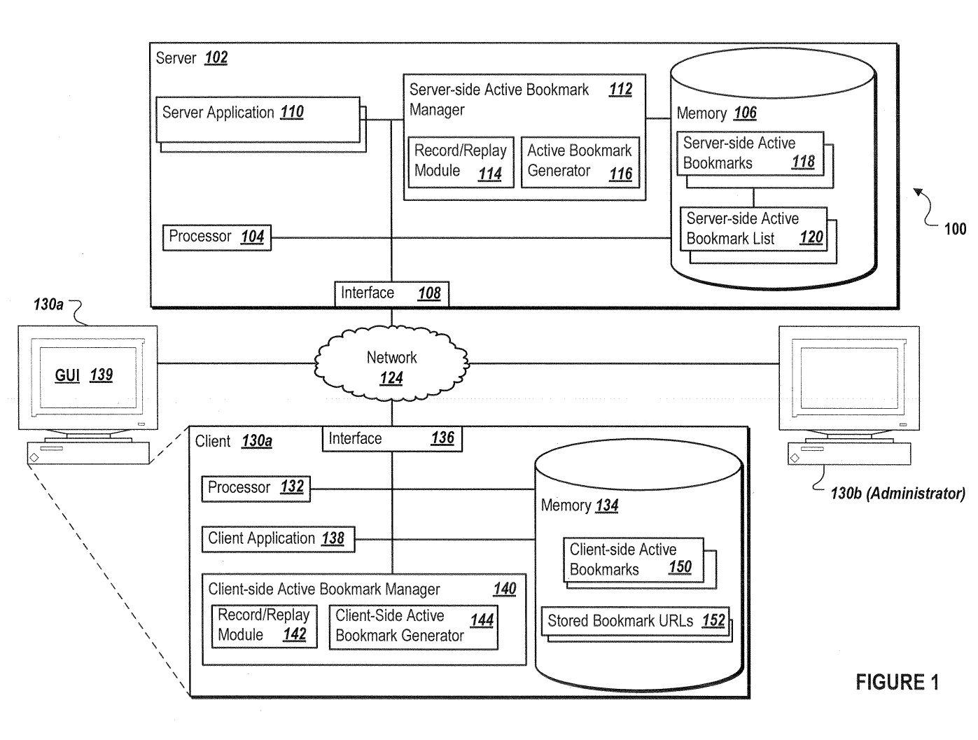

Turning to the example implementation of FIG. 1, the illustrated environment 100 includes or is communicably coupled with server 102 and one or more clients 130, at least some of which communicate across network 124. In general, environment 100 depicts an example configuration of a system capable of creating and using active bookmarks, generated by either the server 102 or one of the clients 130, to provide direct user access to internal pages of web-based applications or web pages.

In general, the server 102 is any server that stores one or more server applications 110, where at least a portion of the server applications 110 are executed via requests and responses with users within and/or communicably coupled to the illustrated environment 100 of FIG. 1. In some instances, the server 102 may store a plurality of various server applications 110, while in other instances, the server 102 may be a dedicated server meant to store and execute only a single server application 110. In some instances, the server 102 may comprise a web server, where the server applications 110 represent one or more web-based applications or web sites accessed and executed via network 124 by the clients 130 of the system 100 to perform the programmed tasks or operations of the server application 110.

At a high level, the server 102 comprises an electronic computing device operable to receive, transmit, process, store, or manage data and information associated with the environment 100. Specifically, the server 102 illustrated in FIG. 1 is responsible for receiving application requests from one or more client applications 138 associated with the clients 130 of environment 100, for responding to the received requests by processing said requests in the associated server application 110, and for sending the appropriate response from the server application 110 back to the requesting client application 138. In addition to requests from the clients 130 illustrated in FIG. 1, requests associated with the server applications 110 may also be sent from internal users, external or third-party customers, and/or other automated applications, as well as any other appropriate entities, individuals, systems, or computers.

As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

In the present implementation, and as shown in FIG. 1, the server 102 includes a processor 104, an interface 108, a memory 106, one or more server applications 110, and a server-side active bookmark manager 112. The interface 108 is used by the server 102 for communicating with other systems in a client-server or other distributed environment (including within environment 100) connected to the network 124 (e.g., clients 130, as well as other systems communicably coupled to the network 124). Generally, the interface 108 comprises logic encoded in software and/or hardware in a suitable combination and operable to communicate with the network 124. More specifically, the interface 124 may comprise software supporting one or more communication protocols associated with communications such that the network 124 or the interface's hardware is operable to communicate physical signals within and outside of the illustrated environment 100.

Generally, the network 124 facilitates wireless or wireline communications between the components of the environment 100 (i.e., between the server 102 and the clients 130), as well as with any other local or remote computer, such as additional clients, servers, or other devices communicably coupled to network 124 but not illustrated in FIG. 1. The network 124 is illustrated as a single network in FIG. 1, but may be a continuous or discontinuous network without departing from the scope of this disclosure, so long as at least a portion of the network 124 may facilitate communications between senders and recipients. The network 124 may be all or a portion of an enterprise or secured network, while in another instance, at least a portion of the network 124 may represent a connection to the Internet. In some instances, a portion of the network 124 may be a virtual private network (VPN), such as, for example, the connection between the client 130 and the server 102. Further, all or a portion of the network 124 can comprise either a wireline or wireless link. Example wireless links may include 802.11a/b/g/n, 802.20, WiMax, and/or any other appropriate wireless link. In other words, the network 124 encompasses any internal or external network, networks, sub-network, or combination thereof operable to facilitate communications between various computing components inside and outside the illustrated environment 100. The network 124 may communicate, for example, Internet Protocol (IP) packets, Frame Relay frames, Asynchronous Transfer Mode (ATM) cells, voice, video, data, and other suitable information between network addresses. The network 124 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, server 102 includes a processor 104. Although illustrated as a single processor 104 in FIG. 1, two or more processors may be used according to particular needs, desires, or particular embodiments of environment 100. Each processor 104 may be a central processing unit (CPU), a blade, an application specific integrated circuit (ASIC), a field-programmable gate array (FPGA), or another suitable component. Generally, the processor 104 executes instructions and manipulates data to perform the operations of server 102 and, specifically, the one or more plurality of server applications 110. Specifically, the server's processor 104 executes the functionality required to receive and respond to requests from the clients 130 and their respective client applications 138, as well as the functionality required to perform the other operations of the server applications 110.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 100, processor 104 executes one or more server applications 110 and a server-side active bookmark manager 112 on the server 102.

At a high level, each of the one or more server applications 110 is any application, program, module, process, or other software that may execute, change, delete, generate, or otherwise manage information according to the present disclosure, particularly in response to and in connection with one or more requests received from the illustrated clients 130 and their associated client applications 138. In certain cases, only one server application 110 may be located at a particular server 102. In others, a plurality of related and/or unrelated server applications 110 may be stored at a single server 102, or located across a plurality of other servers 102, as well. In some cases, a server application 110 may be a web site associated with one or more scripts, applications, or other content. Alternatively, environment 100 may implement a composite server application 110. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the server applications 110 may represent web-based applications accessed and executed by remote clients 130 or client applications 138 via the network 124 (e.g., through the Internet). Further, while illustrated as internal to server 102, one or more processes associated with a particular server application 110 may be stored, referenced, or executed remotely. For example, a portion of a particular server application 110 may be a web service associated with the application that is remotely called, while another portion of the server application 110 may be an interface object or agent bundled for processing at a remote client 130. Moreover, any or all of the server applications 110 may be a child or sub-module of another software module or enterprise application (not illustrated) without departing from the scope of this disclosure. Still further, portions of the server application 110 may be executed by a user working directly at server 102, as well as remotely at client 130.

In some instances, each server application 110 may perform a unique function or provide unique content to a client. In other instances, the plurality of server applications 110 may provide related functionality associated with a larger system, such that a first server application 110 performs a subset of functions associated with an enterprise application (not shown), and a second server application 110 provides another subset of functionality. In any event, at least one of the server applications 110 provides responses to client requests without the use of URL parameters, or in another situation or interaction that makes typical, or traditional, bookmarking of a particular page or portion of the server application 110 generally unavailable to users. In some instances, a portion of the server application 110 may allow for typical bookmarking, while other portions of the server application 110 do not. Where the server application 110 represents a bank web site, a public portion of the web site may provide URLs including visible parameters, while private or user-specific portions of the web site, such as account access, use parameters encrypted in the various HTTP requests, responses, and page transitions to maintain state and store relevant user and session information. In still other instances, one or more of the server applications 110 may be a web page or collections of associated web pages stored on, managed by, and provided in response to requests from clients 130 and/or client applications 138. Generally, server applications 110 are capable of interacting with one or more clients 130 and/or client applications 138 through a request/response choreography via network 124.

As illustrated, processor 104 also executes the server-side bookmark manager 112. Similar to the server applications 110, the server-side active bookmark manager 112 may generally be any application, program, module, process, or other software that may execute, change, delete, generate, or otherwise manage information according to the present disclosure, particularly in order to create, use, and manage one or more server-side active bookmarks associated with one or more of the plurality of server applications 110. The server-side active bookmark manager 112 may be separate from the server applications 110, while in other instances, the server-side active bookmark manger 112 may be embedded within or part of a particular one or more of the server applications. In some instances, some or all of the server applications 110 may include the server-side active bookmark manager 112 as part of the server applications' 110 internal code, while in other instances, some or all of the server applications 110 may be communicably coupled to the server-side active bookmark manager 112, allowing the server applications 110 to access and take advantage of the functionality provided by the server-side bookmark manager 112.

As illustrated, the server-side active bookmark manager 112 includes a record/replay module 114 and an active bookmark generator module 116. These modules may be embedded within the server-side active bookmark manager 112 as shown in FIG. 1, or instead may be communicably coupled to the server-side active bookmark manager 112 within the server 102. In still further instances, either or both of the modules may be located external to the server 102 and perform their relative functionality through communications and interactions facilitated by network 124. Each module may be an agent, daemon, object, service, plug-in, or other software capable of performing the respective module's functionality and operations. Additionally, each module may simply represent a portion of the server-side active bookmark manager 112 (and in some instances, the server application's 110) programming, such that the module itself is inseparable from or an integral part of the server-side active bookmark manager 112.

Turning to the first of the two modules, the record/replay module 114 is used by the server 102, and in connection with one or more of the server applications 110, to record and replay the interactions of a client 130 with the server application 110. Specifically, the record/replay module 114 may be capable of intercepting or receiving a series of client requests and server application responses sent between a client 130 and one of the server applications 110, such that the particular interaction can be recorded, stored, and replayed when requested. In some instances, the record/replay module 114 can receive a start and stop recording command from the client 130 or client application 138 that determines when a client/server application interaction is to be recorded. Alternatively, the record/replay module 114 may be run continuously during multiple client/server application interactions, with certain portions of the interaction being selected or excised for further processing after some particular action has been performed. Generally, the record/replay module 114 is capable of interpreting and recording the parameters, selections, and other information included within each recorded client request. Additionally, the record/replay module 114 may in some instances be capable of interpreting and recording the server application's 110 responses and return parameters or values included within those responses. The functionality of the record/replay module 114 at server 102 generally allows a series of client/server interactions to be recorded, and, based on either a client- or server-based indication, send the recorded interactions, requests, and parameters to the second module of the server-side active bookmark manager 112 and the active bookmark generator 116. In some instances, the record/replay module 114 may only record the steps or information necessary to move from one screen or transaction in the server application 110 to another. In other words, the entire client request may not be recorded, but only the portions relevant to a change in state between the one or more screens, user interfaces (UIs), services, or states associated with the server application 110.

In addition to recording the client/server application interactions, the record/replay module 114 is also capable of replaying one or more series of client/server application interactions by internally providing the server application 110 with the previously-recorded client requests, and interacting with the application 110 until the end of a recorded set of interactions to continue providing the server application 110 the corresponding client requests and interactions. Thus, the record/replay module 114 allows an entire recorded set of interactions to be performed by the server application 110 without requiring the client 130 to resend the previous requests and request parameters. In some instances, when a particular server-side active bookmark 118 is activated, the server 102 and server application 110 may perform the recorded steps and interactions without displaying the intermediate results to the client 130, instead presenting only the final destination associated with the particular server-side active bookmark 118. This allows the created server-side active bookmarks 118 to be used in a similar manner to a traditional bookmark, in that a client 130 can activate a particular URL associated with the server-side active bookmark 118, and be immediately (after the server application 110 processes the interactions) directed to the final screen or page associated with the server-side active bookmark 118. In these instances, the difference between the server-side active bookmark 118 and a traditional bookmark will be indistinguishable to the end user at the client 130.

The operations of the replay/record module 114 are generally interrelated to the functionality of the active bookmark generator module 116. When a new interaction is recorded, and the server-side active bookmark manager 112 receives an indication that an active bookmark is to be created based on some or all of the recorded interactions, the information and interactions stored at the replay/record module 114 related to the specified portion of the interaction may be provided to the active bookmark generator module 116, where the appropriate server-side active bookmark 118 is generated. In some instances, the active bookmark generator module 116 collects the recorded client requests, from the initial request associated with the identified portion to be included in the active bookmark to the identified portion's final interaction, and generates some type of file storing the set of information defining those interactions. Server-side active bookmarks can be stored in any appropriate format, including a programming script providing instructions for each step of the recorded process (i.e., a VBScript, JavaScript, command file, etc.), an eXtensible Markup Language (XML) document, a text document, or any other suitable file containing the information necessary for the server application 110 to transition to the application states recorded by the record/replay module 114. In general, each server-side active bookmark 118 provides a description of the information and requests necessary to move a particular server application 110 through the recorded states. Once the active bookmark generator module 116 creates a new server-side active bookmark 118, the bookmark 118 can be stored or persisted into memory 106.

In general, memory 106 of server 102 may include any memory or database module and may take the form of volatile or non-volatile memory including, without limitation, magnetic media, optical media, random access memory (RAM), read-only memory (ROM), removable media, or any other suitable local or remote memory component. Memory 106 may store various objects or data, including classes, frameworks, applications, backup data, business objects, jobs, web pages, web page templates, database tables, repositories storing business and/or dynamic information, active bookmarks and databases associated with one or more active bookmarks, and any other appropriate information including any parameters, variables, algorithms, instructions, rules, constraints, or references thereto associated with the purposes of the server 102 and its one or more server applications 110. Additionally, memory 106 may include any other appropriate data, such as VPN applications, firmware logs and policies, firewall policies, a security or access log, print or other reporting files, as well as others.

Specifically, illustrated memory 106 includes a set of server-side active bookmarks 118 and a server-side active bookmark list 120. Although illustrated within memory 106, some or all of the illustrated elements may be located or stored outside of memory 106 and/or server 102 (e.g., in different memories and/or on multiple different servers, as well as in other locations external to, but communicably coupled with, environment 100). For example, the set of server-side active bookmarks 118 may be stored as part of the server-side active bookmark manager 112 or within the server application 110. Additionally, some or all of the server-side active bookmarks 118 may be stored at a location external to server 102. The set of server-side active bookmarks 118 may be located in a logical or physical storage location at server 102, and can be used for storing one or more server-side active bookmarks 118 created by the active bookmark generator 116. In some instances, the set of server-side active bookmarks 118 can be stored in a server-side database associated with the server-side active bookmark list 120.

In one example, the server-side active bookmark list 120 represents an up-to-date list of the currently available server-side active bookmarks 118. In one particular instance, the server-side active bookmark list 120 may be a list linked to the set of server-side active bookmarks 118, such that clients 130 and client applications 138 can send a request or activate a hyperlink associated with a URL with one of the active bookmarks 118 listed. The server application 110 or server 102 can use the server-side active bookmark list 120 to retrieve the appropriate server-side active bookmark 118 in a database storing said active bookmarks. Alternatively, each server-side active bookmark 118 may be directly addressable via a uniquely defined URL, allowing direct access to the various active bookmarks 118. In those instances, the server-side active bookmark list 120 may provide a list of currently available or previously created active bookmarks 118, where the list is available to one or more users or administrators in managing the illustrated environment 100.

The illustrated environment of FIG. 1 also includes one or more clients 130. Each client 130 may be any computing device operable to connect to or communicate with at least the server 102 and/or via the network 124 using a wireline or wireless connection. Further, as illustrated by client 130a, each client 130 includes a processor 132, an interface 136, a client application 138, a graphical user interface (GUI) 139, and a memory 134. In general, each client 130 comprises an electronic computer device operable to receive, transmit, process, and store any appropriate data associated with the environment 100 of FIG. 1. It will be understood that there may be any number of clients 130 associated with, or external to, environment 100. For example, while illustrated environment 100 includes two clients (130a and 130b), alternative implementations of environment 100 may include a single client 130 communicably coupled to the server 102, or any other number suitable to the purposes of the environment 100. Additionally, there may also be one or more additional clients 130 external to the illustrated portion of environment 100 that are capable of interacting with the environment 100 via the network 124. Further, the term “client” and “user” may be used interchangeably as appropriate without departing from the scope of this disclosure. Moreover, while each client 130 is described in terms of being used by a single user, this disclosure contemplates that many users may use one computer, or that one user may use multiple computers.

As used in this disclosure, client 130 is intended to encompass a personal computer, touch screen terminal, workstation, network computer, kiosk, wireless data port, smart phone, personal data assistant (PDA), one or more processors within these or other devices, or any other suitable processing device. For example, each client 130 may comprise a computer that includes an input device, such as a keypad, touch screen, mouse, or other device that can accept user information, and an output device that conveys information associated with the operation of the server 102 (and server application 110) or the client 130 itself, including digital data, visual information, the client application 138, and/or the GUI 139. Both the input and output device may include fixed or removable storage media such as a magnetic storage media, CD-ROM, or other suitable media to both receive input from and provide output to users of the clients 130 through the display, namely, the GUI 139. As indicated in FIG. 1, client 130b is specifically associated with an administrator of the illustrated environment 100. The administrator 130b can modify various settings associated with one or more of the other clients 130, the server 102, the server applications 110, the client applications 138, and/or any relevant portion of environment 100. For example, the administrator 130b may be able to modify the format in which particular active bookmarks are generated, the lifecycle or expiration value associated with newly generated active bookmarks, as well as any other relevant settings associated with the server-side active bookmark manager 112 or a particular client-side active bookmark manager 140 as illustrated internal to client 130a. Additionally, the administrator 130b may be have a configuration option available at the server or associated with the server application that allows the administrator 130b to choose whether a warning, interrupt, or any other message or event is sent during active bookmark creation based on the particular events and interactions associated with a particular server application 110. For example, certain bookmark relevant server state changes, such as deletion steps, creation steps, and modification steps, may require or suggest a certain response or action during active bookmark creation or usage. In those instances, the administrator 130b can modify the associated settings in order to customize the active bookmark experience and interaction.

As illustrated, one or more of the clients 130 include a client application 138 associated with the server application 110. In this instance, “associated with the server application 110” may mean a client-side portion of a specific server application 110 or a standalone application located at the client 130. In general, the client application 138 is any software, such as a web browser or remote portion of the server application 110, that allows the client 130 to access and work with a particular server application 110. Particularly, the client application 138 is a software application that enables the client 130 (or a user thereof) to display and interact with one or more of the server applications 114 executed at the server 102. Where the server applications 110 are web-based applications, the client application 138 may be a specific application dedicated to use with a particular server application 110, a general web browser with adequate functionality to interact with the server application 110 (such as when the server application 110 is a web page, web site, or web-based application), or any other appropriate software. In certain instances, the client application 138 may be capable of interacting with the server 102, a particular server application 110, and the server-side active bookmark manager 112 to create one or more server-side active bookmarks 118. Additionally, as will be described with regards to the additional portions of the client 130a, the client application 138 may be capable of creating, or at least initiating the creation of, one or more client-side active bookmarks 150.

Further, the illustrated client 130 includes a GUI 139 comprising a graphical user interface operable to interface with at least a portion of environment 100 for any suitable purpose, including generating a visual representation of the client application 138 (in some instances, the client's web browser) and the interactions with the server application 110, including the responses received from the server application 110 received in response to the requests sent by the client application 138 or other client software. Generally, through the GUI 139, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 139 can represent any graphical user interface, including but not limited to, a web browser, touch screen, or command line interface (CLI) that processes information in environment 100 and efficiently presents the information results to the user. In general, the GUI 139 may include a plurality of user interface (UI) elements, some or all associated with the client application 138, such as interactive fields, pull-down lists, and buttons operable by the user at client 130. These and other UI elements may be related to or represent the functions of the client application 138, as well as other software applications executing at the client 130. In particular, the GUI 139 may be used to present the client-based perspective of a particular server application 110, and may be used (as a web browser or using the client application 138 as a web browser) to view and navigate the server application 110, as well as various web pages and web-based applications located both internal and external to the server, some of which may be associated with particular server applications 110. For purposes of the present disclosure, the GUI 139 may be a part of or the entirety of the client application 138, while also merely a tool for displaying the visual representation of the client and server applications' 110 actions and interactions. In some instances, the GUI 139 and the client application 138 may be used interchangeably, particularly when the client application 138 represents a web browser associated with the server application 110. Further, one or more of the UI elements presented in the GUI 139 may represent buttons or other interactive UI elements that can indicate to either the server 102 (via the server-side active bookmark manager 112) or the client 130a (via the client-side active bookmark manager 140) that a new active bookmark should be created, or that the creation of an active bookmark should be initialized.

Similar to the server 102, the illustrated clients 130 include both an interface 136 and a processor 132. The interface 136 of each client 130 may be similar to interface 108 of the server 102, in that it may comprise logic encoded in software and/or hardware in a suitable combination and operable to communicate with the network 124. More specifically, interface 136 may comprise software supporting one or more communication protocols such that the network 124 or hardware is operable to communicate physical signals to and from the client 130. The client's processor 132 may also be similar in nature to that of the server's processor 104. Again, although only illustrated as a single processor 132, two or more processors may be used according to particular needs, desires, or embodiments of environment 100. Similar to the server's processor 104, each client processor 132 may be a central processing unit (CPU), a blade, an application specific integrated circuit (ASIC), a field-programmable gate array (FPGA), or another suitable component. Generally, the processor 132 executes instructions and manipulates data to perform the operations of the client 130 and, specifically, the associated client application 138 described above. Specifically, the client's processor 132 executes the functionality required to send requests from the client 130 and its client application 138, as well as receive and process the associated responses from the server applications 110.

In addition to executing the client application's 138 functionality, processor 132 also executes the client-side active bookmark manager 140. The client-side active bookmark manager 140 is generally any application, program, module, process, or other software that may execute, change, delete, generate, or otherwise manage information associated with client-side active bookmarks 150. The client-side active bookmark manager 140 may be separate from the client application 138, while in other instances, it may be embedded within or part of the functionality of the client application 138. As illustrated, the client-side active bookmark manager 140 includes two modules: a client-side record/replay module 142 and a client-side active bookmark generator 144. In general, the client-side active bookmark manager 140 provides a tool for creating a client-side active bookmark 150 at the client 130 with minimal assistance from the server application 110. In some instances, environment 100 may provide either a server-side active bookmark manager 112 or a client-side active bookmark manager 140, but not both. In other instances, such as that illustrated in FIG. 1, active bookmarks can be generated at either the client 130 or the server 102, and both a client-side active bookmark manager 140 and a server-side active bookmark manager 112 may be available to implement both solutions. As will be described, different methods and elements can be used to accomplish the active bookmark creation in the two cases.

The illustrated client-side modules may be embedded within the client-side active bookmark manager 140 as shown in FIG. 1, or instead may be communicably coupled to the client-side active bookmark manager 140 on client 130. In still further instances, either or both of the modules may be located external to the client 130 and perform their relative functionality through communications and interactions facilitated by network 124. Each module may be an agent, daemon, object, service, plug-in, or other software capable of performing the respective module's functionality and operations. Additionally, each module may simply represent a portion of the client-side active bookmark manager 140 (and in some instances, the client application's 138) programming, such that the module itself is inseparable from or an integral part of the client-side active bookmark manager 140.

The first illustrated module of the client-side active bookmark manager 140 is the record/replay module 142. The client-side record/replay module 142 records user (and/or client application 138) interactions with the server 102 and server application 110 during a particular session, specifically recording the information, data, and user actions performed in order to move from one screen or page to another of the associated server application 110. In the client-side embodiment of the active bookmark creation, the server 102 and server application 110 may not be aware or notified that recording is occurring. Instead of recording the interactions at server 102, the interactions are recorded at the client 130 by the client-side record/replay module 142 in the client-side embodiment. Specifically, the information and data included in requests to the server application 110 for a specified set of interactions are recorded and stored by the record/replay module 142. The record/replay module 142 can also be used to replay recorded interactions from a generated active bookmark 150 via the client application 138.

Once the interactions, and specifically, the user actions and requests, are recorded by the record/replay module 142, the client-side active bookmark generator 144 uses the recorded information and interactions to create a client-side active bookmark 150 that allows the user to replay or reenact the interactions that allowed a particular interaction to get from a first page of the associated server application 110 to a final page associated with the end of the active bookmark 150. Similar to the server-side implementation, the generated client-side active bookmark 150 may be stored as any particular type of file, including a script or scripting file that can be executed by the local client-side active bookmark manager 140 to provide the recorded transitions within the server application 110, as well as a client-side database storing information associated with one or more client-side active bookmarks. In some instances, the generated active bookmark 150 may be provided its own file extension, such as “.activebookmark” or any other appropriate extension, which can signal to the client application 138 that when the active bookmark 150 is activated the record/replay module 142 is to interpret and replay the interactions stored in the active bookmark 150. Alternatively, the active bookmark 150 may be stored as an XML file, a text file, or any other file suitable for storing the information associated with the recorded interactions. Additionally, the client-side active bookmark generator 144 may embed a portion of executable code or instructions for performing the interactions inside the client-side active bookmark 150 such that the active bookmark 150 can be used by any client 130 or user receiving a copy of the file (such as a .bat or .exe file). In instances where a new extension is defined for the client-side active bookmarks, the new extension can be registered with the operating system or client application 138 to recognize the format or contents of the active bookmark 150 and perform the related functionality and interactions associated with the particular active bookmark 150. Once the new file extension is registered, users may activate or open the active bookmark 150 (i.e., by double-clicking on an active bookmark icon on the client's desktop or GUI 139), and subsequently, allow the client application 138 (in some instances, via the replay functionality of the record/replay module 142) to perform the exact interactions recorded during the creation of the active bookmark 150. One advantage of an executable active bookmark, as well as the other file types, is that a copy of the file can be sent to any other client 130 or user with information relating to and defining the interactions required to reach a particular final screen associated with the active bookmark. By doing so, screens previously accessible only by screenshots or written description (but not by a specific URL) can be reached using a mechanism likely familiar to both professional and casual users.

As illustrated, each client 130 includes a memory 134. Memory 134 may be similar to the server's memory 106, and may include any memory or database module, taking the form of either volatile or non-volatile memory including, without limitation, magnetic media, optical media, random access memory (RAM), read-only memory (ROM), removable media, or any other suitable local or remote memory component. For example, memory 134 may store backup data, parameters, cookies, variables, algorithms, instructions, rules, or references thereto, as well as any other suitable data. Specifically, memory 134 may store both the client-side active bookmarks 150 generated by the client-side active bookmark manager 140 and a set of traditional bookmarked URLs 152 associated with any server-side active bookmarks 118. In some instances, such as where only a client-side solution is implemented, the traditional bookmarked URLs 152 related to server-side bookmarks may be omitted, while in server-side solutions, the client-side active bookmarks 150 may not be included. Additionally, both sets of data can be stored elsewhere, such as another memory internal or external to the client 130, or within one of the other components of the client 130, such as the client application 138 or the client-side active bookmark manager 140. In some instances, environment 100 may provide instances of both client-side and server-side active bookmarks, allowing users additional freedom in creating and providing advanced active bookmarks.

While FIG. 1 is described as containing or being associated with a plurality of elements, not all elements illustrated within environment 100 of FIG. 1 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein. For example, some implementations may be limited to the creation and use of only server-side active bookmarks, while other implementations may only be enabled for client-side active bookmarks.

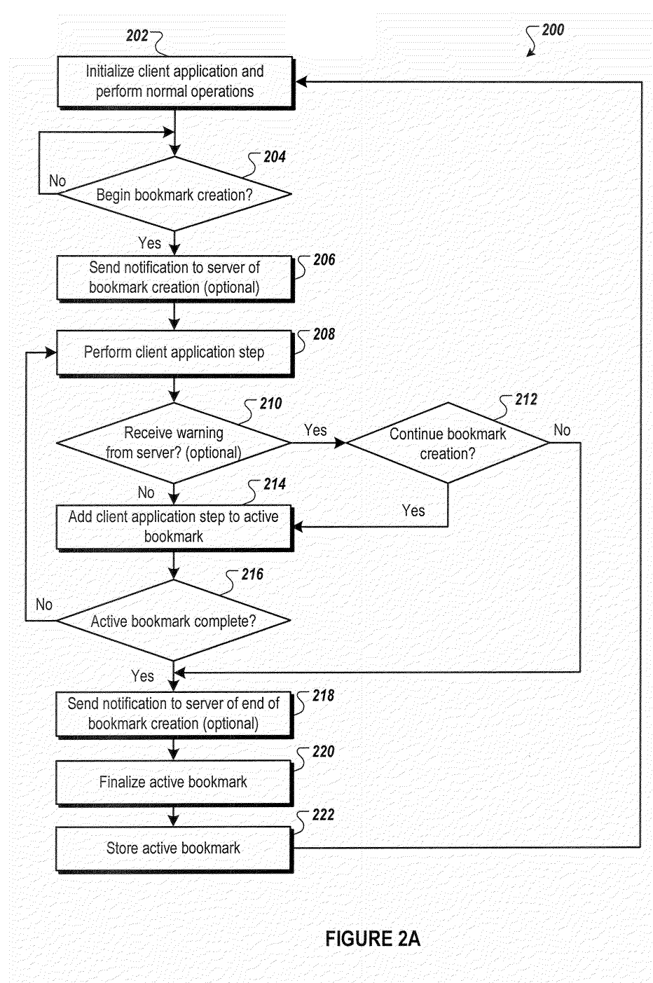

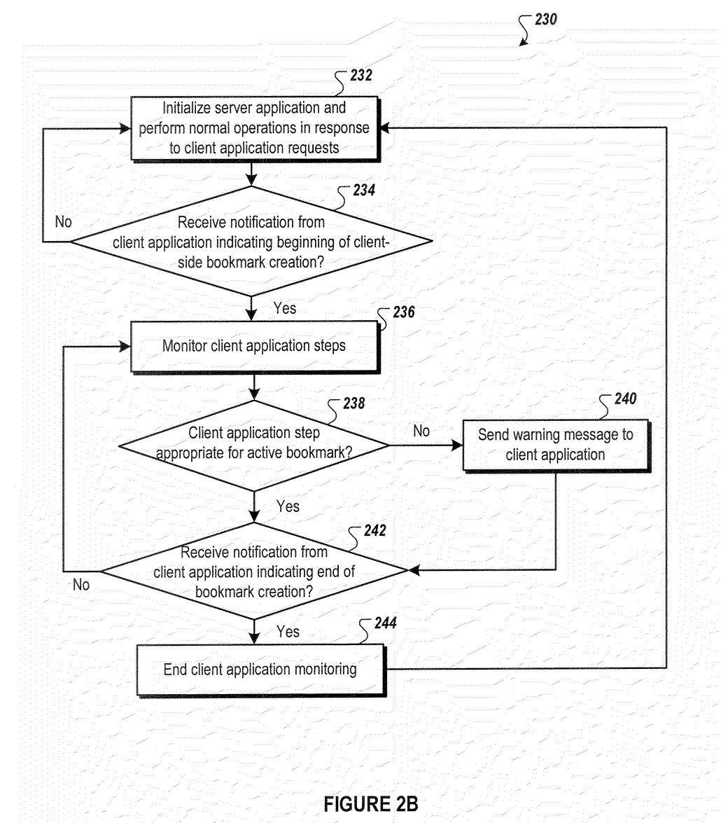

FIG. 2A is a flowchart illustrating one particular implementation of a computer implemented method or process 200 for client-side creation of an active bookmark from the perspective of a client. For clarity of presentation, the description that follows generally describes method 200 in the context of environment 100 illustrated in FIG. 1. However, it will be understood that method 200 may alternatively be performed by any other suitable system, environment, or combination of systems and environments, as appropriate.

At 202, a client initializes an instance of a client application and begins performing normal operations. At 204, the client determines whether to begin the creation of a client-side active bookmark. In some instances, this determination may be based on whether or not a particular notification or indication is received by the client application, such as an explicit user action indicating that a client-side active bookmark is to be created. In other instances, the creation of active bookmarks may be based on predefined events or actions, such as entering or interacting with a website or server application whose associated URLs do not include the parameters necessary to generate a traditional bookmark. In such examples, the client may automatically begin the creation of a client-side active bookmark for all client/server application interactions without traditionally-bookmarkable URLs, and only when the interaction is complete, ask the user or client whether a corresponding active bookmark should be generated. If the client determines that client-side active bookmark creation is not needed or indicated at this time, method 200 returns to the normal operations of the client application. However, if the client determines that a new client-side active bookmark is to be created, method 200 continues at 206.

At 206, the client may optionally send a notification to the server and/or server application that a client-side active bookmark is being generated. In some implementations, this step may be omitted. The usefulness of this notification is that in some systems and environments, certain interactions with the server and/or server application may not be suited for an active bookmark. By providing the notification to the server application, any such warnings can be relayed to the user. For example, security-relevant systems, such as a human resources system or an information technology system, may contain sensitive information that, if disseminated, could violate privacy and/or security protocols associated with an entity or regulation. Additionally, some information may be sensitive to the particular user creating the active bookmark, such as the entering of passwords or other sensitive personal information, that such interactions may be suggested by the server application to not be included within the client-side active bookmark without further consideration.

At 208, a client application step or action is performed. At 210, the client determines whether any warnings or suggestions from the server application are received with regard to the recording of the action for the active bookmark. As previously noted, this step is optional and generally requires that the server application has been made aware that a client-side active bookmark is being created at optional 206. If no warning or suggestion is received, then method 200 continues at 214. In cases where a warning or suggestion is received from the server at 210, the client determines whether to continue the creation of the client-side active bookmark at 212. In some instances, the user may not have an option to continue, depending on the settings associated with the server application and any permissions set with relation to active bookmark creation. In other instances, the user may have to make an active selection in order to continue with the bookmark's creation, such as by clicking a radio button or other UI element presented at a GUI associated with the client application. If the user elects to end the bookmark creation, method 200 moves to 218 for further processing. However, if the user elects to continue bookmark creation, method 200 continues at 214.

At 214, the previous client application step is added to the active bookmark. In some instances, the information and data associated with the step is added to a queue of client interactions stored at the client, such as in the record/replay module 142 illustrated in FIG. 1. In other instances, each client interaction and its associated information can be placed into temporary storage, or added to a partially completed active bookmark by the client-side active bookmark generator 144. In some instances, the information associated with the client action may be added to a text, XML, or log file and saved for future use.

Once the client application step is added to the active bookmark or associated storage location, the client determines whether the active bookmark is complete at 216. Similar to the start of the client-side active bookmark's creation, the determination that the active bookmark is complete may be provided manually by a user at the client or determined automatically based on a certain event or result. If the client determines that additional steps will be included in the active bookmark, method 200 returns to 208 where additional client application steps and interactions are performed. However, if the active bookmark is complete, method 200 continues at 218.

At 218, the client can optionally send a notification to the server and/or server application that the recording process is complete, such that no future warnings or suggestions are necessary. Again, this step is optional and requires the server and/or server application to be aware that the client-side active bookmark is being generated. In many instances, the server and server application will be unaware of a particular client-side active bookmark, both during creation and during the client-side active bookmark's use.

Continuing at 220, the client finalizes the active bookmark. In some instances, finalizing the client-side active bookmark may comprise the recorded interactions being sent from a record/replay module to an active bookmark generator. Additionally, finalizing the active bookmark may include formatting the recorded interactions in accordance with the particular file type used to create the active bookmark. Where the active bookmark represents an executable file, finalizing the active bookmark may include encoding the executable code with the client interaction information. In any event, finalizing the client-side active bookmark includes creating and finalizing an active bookmark that allows the client, and in some instances, any other user with access to the active bookmark, to replay the events associated with the active bookmark and return to the final location or screen associated with the recorded interactions.

Once the active bookmark is finalized, the active bookmark can be stored at 222. As illustrated in FIG. 1, client-side active bookmarks 150 may be stored in a memory local to the client. In alternative embodiments, the active bookmark may be stored at any location accessible by the client, such as in association with the client application, or in some location external to the client. Additionally, once the active bookmark has been created, it may be sent to one or more other clients, users, or other entities, such as technical support personnel, such that the file storing the active bookmark can be accessed and used by one or more users other than the user associated with the active bookmark's creation. After storage, method 200 returns to 202, performing the normal operations of the client application, until a new client-side active bookmark is to be created.

FIG. 2B is a flowchart illustrating a particular implementation of a computer implemented method or process 230 for client-side creation of an active bookmark from the perspective of a server associated with a particular server application. This particular illustration is associated with method 200 of FIG. 2A, in that the client of FIG. 2A is interacting with the server of FIG. 2B. Similar to FIG. 2A, method 230 is generally described in the context of environment 100. It will be understood that method 230 may be performed by alternative systems and environments, as well as in connection with different methods than as described, where appropriate.

At 232, the server application associated with the server can be initialized and perform its normal operations in response to one or more client (or client application) requests. In some instances, the server application may be associated with multiple clients at once, and running several instances or sessions of the particular server application. At 234, the server determines whether it or the server application have received a notification from the client or client application indicating the start of a client-side active bookmark creation. If no notification is received, method 230 returns to normal processing of the server application at 232. In some implementations, no notifications will ever be received from the client or client application regarding client-side active bookmark creation. In those instances, method 230 simply remains at 232 until the server application is complete, no interactions are requested, or the server application is closed. In others, notifications may be sent from certain clients or client applications, while other clients and client applications will not send notifications.

If a notification is received at 234, method 230 continues at 236 where the server and/or the server application monitor the client application steps sent to the server application. This monitoring allows the server application and server to protect sensitive information from the active bookmark, as well as to notify the client when certain steps are not available for recording, or when certain steps are not likely to be of assistance in the active bookmark. Specifically, at 238 the server application determines whether the current client application step is appropriate for a client-side active bookmark. As previously discussed, certain secure systems may be set to not allow active bookmarks to be created for certain steps or processes, such as when accessing critical or privileged information. Additionally, some actions, such as creating a new model or entry into the system, are unique events that should only be performed once, and thus should not be repeated during replay of a bookmark.

If the server application determines that the client application step is inappropriate for a client-side active bookmark, or that the step should be given further consideration by the user before including it in the active bookmark, a warning message can be sent to the client application for presentation to the user at 240. In some instances, the warning message may include a command or response from the server application stopping or interrupting the client-side active bookmark generation process, while in others, only the warning message itself is sent. Still further, certain implementations may automatically stop the server application or refuse to respond to a client application step if the event or interaction being recorded is set such that recording is explicitly refused. Once the warning message is sent, method 230 continues at 242.

At 242, the server and server application determine whether an additional notification form the client or client application indicating the end of an active bookmark creation is received. If no such indication is received, method 230 returns to 236 where the server and/or server application continue to monitor the various interactions associated with the client application. If, however, such notification is determined to be received, method 230 continues to 244, where the server application ends its monitoring of the client application's interaction, and subsequently, continues back to 232 to perform the server application's normal operations.

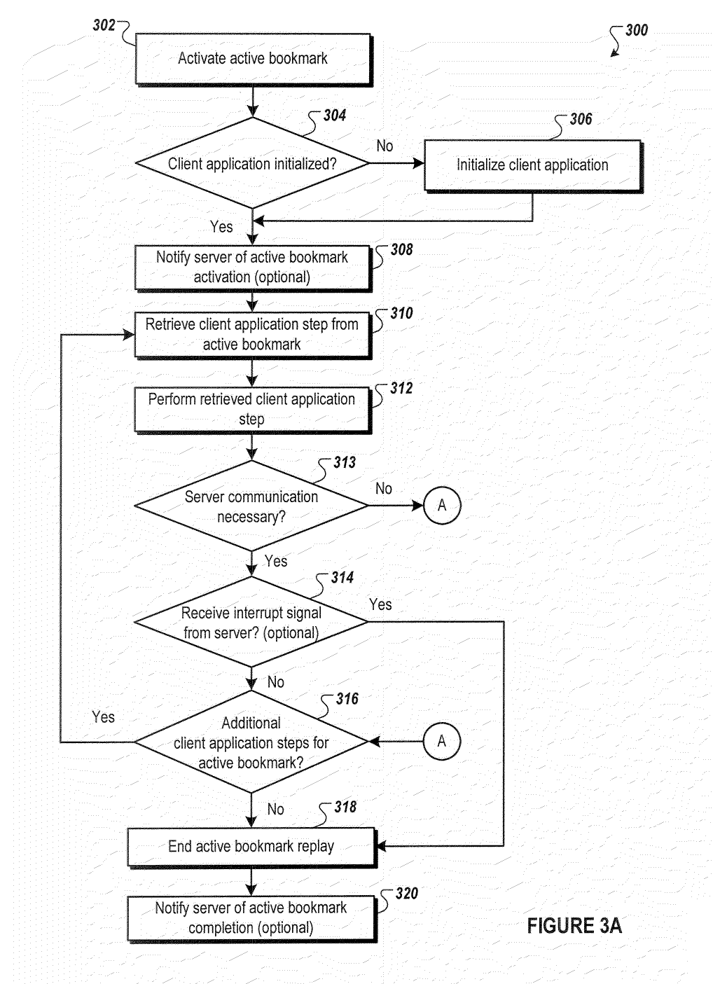

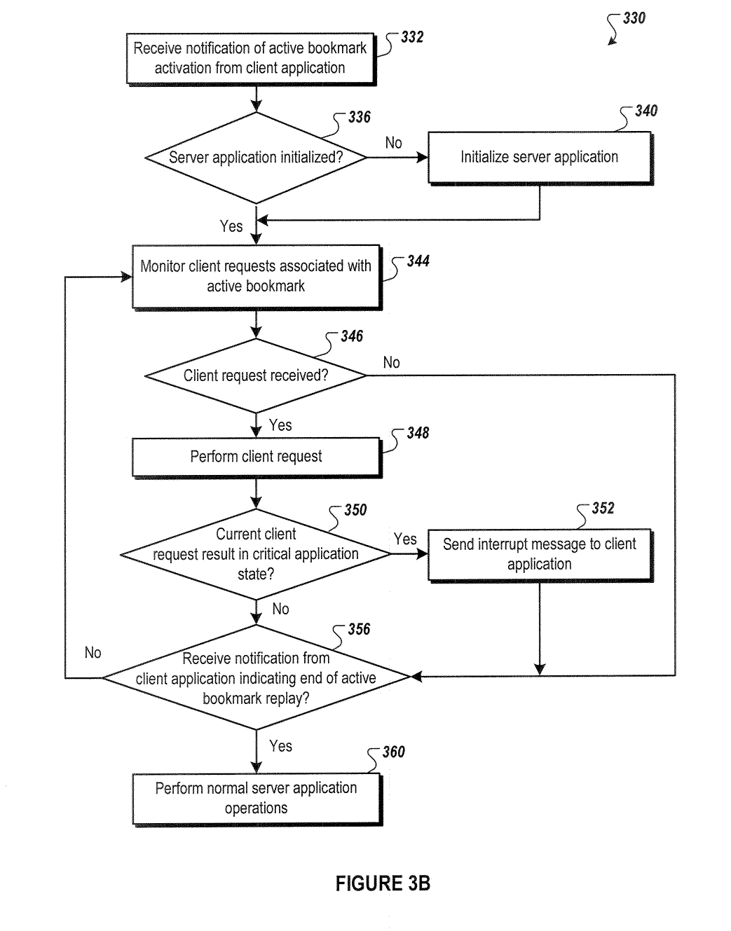

FIG. 3A is a flowchart illustrating a particular implementation of a computer implemented method or process 300 for using a client-side active bookmark from the client's perspective. This particular illustration is associated with method 200 of FIG. 2A, in that the active bookmark used in method 300 was created using method 200 described therein. Although based on that method of creation, method 300 may be used with any appropriate client-side active bookmark, including those generated by methods or processes other than those described in FIG. 2A.

At 302, the client, or a user at the client, activates the client-side active bookmark. In some instances, activating the active bookmark may include double-clicking on an icon associated with the client-side active bookmark located on the client's desktop, or selecting the client-side active bookmark from a stored list of client-side active bookmarks. If the client-side active bookmark has been sent via email, the active bookmark may be activated within a particular email client. Additionally, in some instances, a client application may be capable of explicitly calling or activating a client-side active bookmark through its own operations, such that activating the active bookmark is performed through one or more screens or visual interfaces presented at the GUI 139 to a user.

At 304, the client determines whether or not the client application is initiated. In instances where the client-side active bookmark is represented by a desktop icon, the client application may not be running when the bookmark is activated. Other methods of activating the client-side active bookmark may also be possible without having the client application running. If the client determines that the client application (or an instance thereof) is not initialized, then method 300 initializes the client application at 306. Once the client application is initialized at 306, or if the client determines that the client application was already initialized at 304, method 300 continues at 308.

At 308, the client and/or the client application may optionally notify the server and/or the server application associated with the client-side active bookmark that an active bookmark has been activated. By notifying the server and server application of an active bookmark's activation, the server and/or server application can monitor the client application interactions to determine whether any particular requests should be denied, or at least confirmed, during the replay of the active bookmark.

At 310, a first client application step is retrieved from the active bookmark. In some instances, this may require the client application to read a first action from the active bookmark file. In other instances, an executable application bookmark file may automatically supply the first action, step, command, or request defined in the file to the client. At 312, the first retrieved action, step, command, or request is performed by the client application. In some instances, the actions associated with the client-side active bookmark may not require server interaction. For instance, the first step may be associated with one or more parameters being set by or for the client application locally. In those instances, no client request needs to be sent to the server application. Therefore, method 300 determines at 313 whether a communication to the server is necessary to perform the first retrieved step. If no communication to the server is required, method 300 move to 316. If, however, communication to the server is required for the retrieved step, method 300 continues at 314.

At 314, the client and/or client application determines whether an interrupt signal has been received from the server in response to the server communication (i.e., client request). An interrupt signal may include a message from the server noting that a particular request associated with the active bookmark will not be performed, a warning that performing a particular step may cause privileged or other sensitive data to be exposed, and/or a request for confirmation as to whether the replay of the active bookmark should continue. Generally, this portion of method 300 is optional, and may be limited to instances where the server is notified that an active bookmark has been activated, such as at 308 of method 300. Additionally, certain implementations may only provide warning messages, or may only suggest ending the active bookmark replay, allowing the client to choose whether to continue or not. In instances where the interrupt signal is a command or request from the server application to end the active bookmark replay, or where the client chooses to end the active bookmark replay as a result of the interrupt message, method 300 skips to 318 and the active bookmark replay is ended. If however, the interrupt signal is either not received and/or acted upon by the client, method 300 continues at 316.

At 316, the client and/or client application determines whether additional client steps are included within the active bookmark. If additional steps remain, method 300 returns to 310 where the next client application step or interaction is retrieved from the active bookmark, and the active bookmark replay is continued. If instead, however, no additional application steps are associated with or defined by the active bookmark, method 300 continues to 318. At 318, the client-side active bookmark replay is ended. When the active bookmark replay has completed and has not been prematurely ended by the server or user, the client application should be placed in an identical or similar state as that previously recorded, such as during the execution of the original steps performed during the creation of the client-side active bookmark (e.g., the client application steps of FIG. 2A). In some instances, the client or client application may notify the server that the replay of the active bookmark is complete at 320. Generally, this step may only be performed when 308 and 314 are also part of method 300, although certain implementations may include all, a subset, or none of the optional steps.

FIG. 3B is a flowchart illustrating a particular implementation of a computer implemented method or process 330 for using a client-side active bookmark from the server's perspective. This particular illustration is associated with method 200 of FIG. 2A and method 230 of FIG. 2B, in that the active bookmark used in method 300 was created using method 200 described therein, as well as method 300 of FIG. 3A describing the client-side perspective of using a client-side active bookmark. Although associated with these other methods, method 330 may be used with any appropriate client-side active bookmark, including those generated by methods or processes other than those described in FIG. 2A, as well as another method for using the client-side active bookmark at the client.

At 332, the server and/or server application receives a notification of an active bookmark activation from the client and/or client application. In some implementations of client-side active bookmarks, the server and server application may not be made aware of an activation of a client-side active bookmark. In those instances, the server and server application merely perform their normal operations in response to requests from the client and/or client application. It is assumed in FIG. 3B that the server and server application are notified of the active bookmark's activation.

After receiving the notification, the server determines whether an instance of the server application is initialized at 336. If not, the server application is initialized at 340. If the server application is initialized when the notification is received, method 330 continues at 344. At 344, the server and/or server application monitor one or more client requests associated with the active bookmark. In some instances, the active bookmark may require only a single interaction at the server. In those instances, only one client request may be received at the server. In other instances, the client-side active bookmark may be more involved and include a plurality of interactions and requests.

At 346, the server and/or the server application determine whether a client request is received. If no client request is received, method 330 continues at 356. If a client request is received, however, the client request is performed at 348. During the execution of the client request, the server and server application determine whether the current client request results in or is associated with a critical server application state at 350. If a critical server application state is not involved, method 330 continues at 356. If, however, a critical application state is involved, method 330 continues at 352. For example, if privileged information is required or associated with the client request, or an operation that should not be repeated or replayed is requested, the server and/or server application can determine that an interrupt message is to be sent to the client application at 352. In some instances, the interrupt message may include an indication, command, or request that a client-side active bookmark step should not be performed, should be confirmed before execution, or that the client-side active bookmark should end its replay. Other such messages may also be used as appropriate for the type of critical code involved. Once the message is sent, method 330 continues at 356.

At 356, the server and/or server application determine whether a notification from the client application has been received that the client-side active bookmark replay is complete. If no such notification is received, method 330 returns to 344 to monitor the client requests associated with the client-side active bookmark. If, however, the notification is received, then method 330 ends it monitoring of client requests that result in a critical server application state and returns to its normal server application operations at 360.

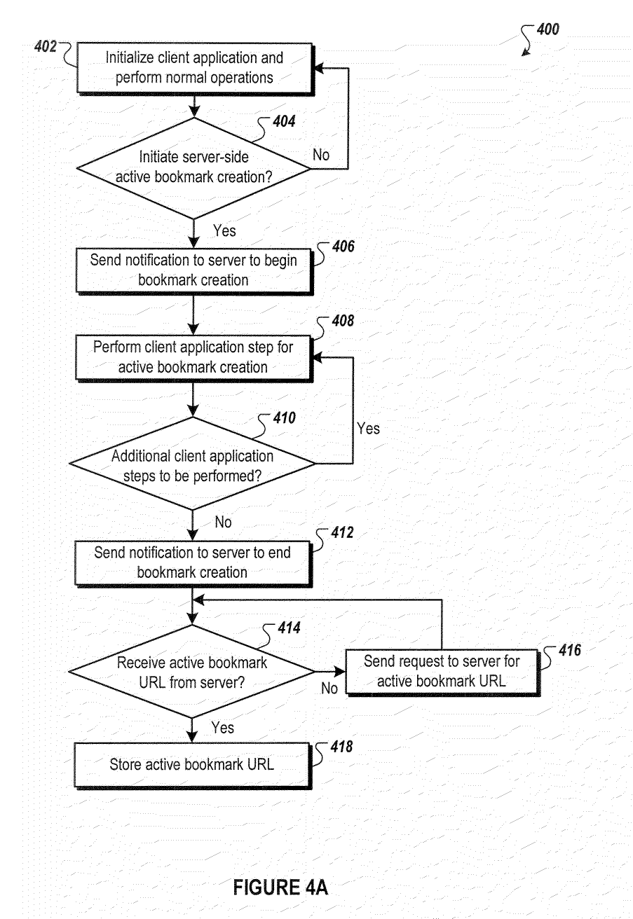

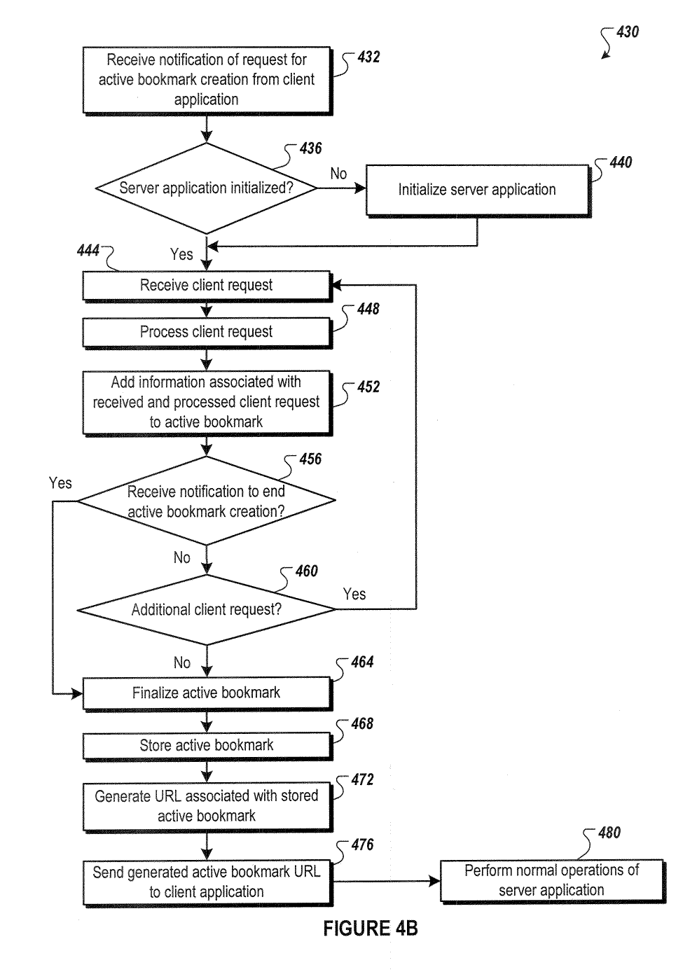

FIG. 4A is a flowchart illustrating one particular implementation of a computer implemented method or process 400 for the creation of a server-side active bookmark from the client's perspective. For clarity of presentation, the description that follows generally describes method 400 in the context of environment 100 illustrated in FIG. 1. However, it will be understood that method 400 may alternatively be performed by any other suitable system, environment, or combination of systems and environments, as appropriate.

At 402, the client application is initialized and performs its normal operations. At 404, the client application determines whether the creation of a server-side active bookmark should be initiated. In some instances, this determination is based on a manual request received from a user, such as a request received through a button or other UI element displayed on the client GUI and associated with the client application. In other instances, certain events or settings associated with the client application may indicate that a server-side active bookmark should be created. In another alternative, a request to create a server-side active bookmark may be received or generated from outside of the client application, and in some cases, from external to the client. If the client application determines that no active bookmark should be created at 404, method 400 returns to 402 as the client application performs its normal operations. If, however, the client application determines that a server-side active bookmark is to be created, method 400 continues at 406.

At 406, the client application sends a notification to the server that a server-side active bookmark is to be created in accordance with one or more subsequent actions. Once the notification has been sent, the client application performs a first step or interaction with the server application to begin the server-side active bookmark creation at 408. Generally, only information sent to the server will be recorded for server-side active bookmarks. In suitable situations, additional information may be sent via a separate module or program from the client for inclusion in the server-side active bookmark. Although not illustrated within FIG. 4A, the client application may receive a notification from the server with a warning message associated with one or more of the client steps that a user attempts to include within the server-side active bookmark. The process may be similar to that illustrated at 210 of FIG. 2A, and appropriate action in response to the notification may be taken by the user, client application, and server application. In some instances, the client may be able to continue bookmark creation, while in others, the server application may end bookmark creation. Additionally, the server application may exclude, or censor, certain actions from the active bookmark being created.

At 410, the client determines whether additional client application steps associated with the server application are to be performed, and specifically, whether those steps to be performed are to be included in the server-side active bookmark. If additional steps associated with the active bookmark are to be performed, method 400 returns to 408 where the additional client application step or interaction is performed. If no additional client application steps are to be performed for the server-side active bookmark, method 400 continues at 412. In some instances, the user of a client application may manually select when to stop or end the creation of the server-side active bookmark. Similar to 404, the ending of the server-side active bookmark creation may be based on user input provided via a particular UI element from the GUI of the client application, as well as any other suitable method for indicating the end of the active bookmark recording. Alternatively, certain events, interactions, or other actions outside direct instruction from the user may indicate to the client application that no additional steps are to be added to the server-side active bookmark. For instance, if no interactions are received for a predefined period of time (i.e., a timeout value associated with the client application), then the client application may end the creation of the active bookmark. After determining no additional client application steps or interactions are to be included in the server-side active bookmark, the client application sends a notification to the server to end the bookmark creation at 412.

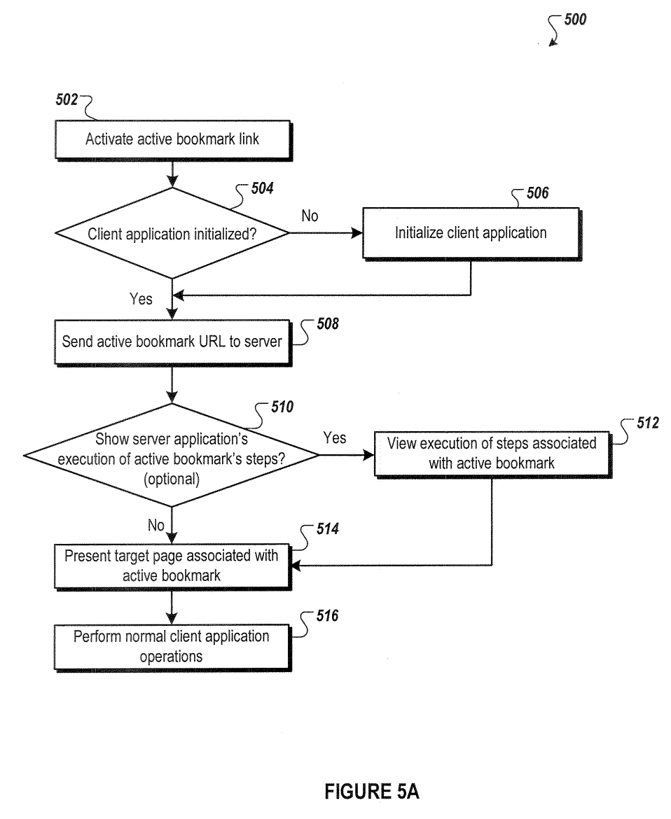

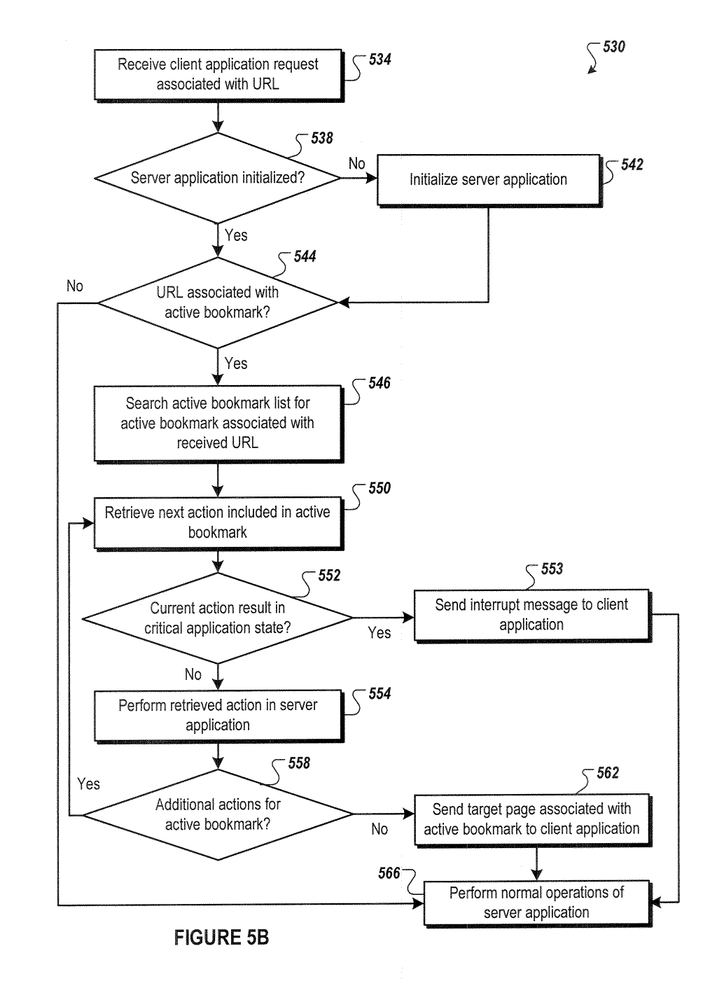

At 414, the client application determines whether or not a URL associated with the created active bookmark is received from the server. The active bookmark URL defines a link to the server associated with the created server-side active bookmark, which can be accessed by the client application in the same manner as a traditional bookmark (see FIG. 5A for further description). If the active bookmark URL has not been received after a predefined amount of time, the client application can send a request to the server for the URL to be returned at 416. Once the active bookmark URL is received, the client application stores the active bookmark URL locally for future access to the server-side active bookmark at 418.

FIG. 4B is a flowchart illustrating one particular implementation of a computer implemented method or process 430 for the creation of a server-side active bookmark from the server's perspective. This particular illustration is associated with method 400 of FIG. 4A, in that the client of FIG. 4A is interacting with the server of FIG. 4B. Similar to FIG. 4A, method 430 is generally described in the context of environment 100. It will be understood that method 430 may be performed by alternative systems and environments, as well as in connection with different methods than as described, where appropriate.

At 432, the server and/or server application receives a notification from the client application requesting the creation of a server-side active bookmark. At 436, the server determines whether or not the server application has been initialized. If not, the server application is initialized at 440. If the server application has been initialized, method 430 continues at 444.

At 444, the server application receives a client request. At 448, the server application processes the client request as normal, enacting any server state changes or responses as necessitated by the client request. In general, the server application performs its normal operations related to the received client request. Although not illustrated in FIG. 4B, the server application and/or server may monitor the received client requests to protect sensitive information from being included within the active bookmark, as well as to notify the client when certain steps are not available for recording, or when certain steps are not likely to be of assistance in the server-side active bookmark. Specifically, at As previously discussed, certain secure systems may be set to not allow active bookmarks to be created for certain steps or processes, such as when accessing critical or privileged information. Additionally, some actions, such as creating a new model or entry into the system, are unique events that should only be performed once, and thus should not be repeated during replay of a bookmark.

If the server application determines that the actions associated with the client request are inappropriate for a server-side active bookmark, or that the step should be given further consideration by the user before including it in the active bookmark, a warning message can be sent to the client application. In some instances, the warning message may include a command or response from the server application stopping or interrupting the server-side active bookmark generation process, while in others, only the warning message itself is sent. Still further, certain implementations may automatically stop the server application or refuse to respond to a client request if the event or interaction being recorded is set such that recording is explicitly refused. Once the warning message is sent, method 430 can continue.

At 452, the server application, or a related module, adds the information associated with the received and processed client request (or at least the information necessary to change the server application's state from pre-client request to post-client request) to an active bookmark file. In some instances, one or more parameters defining or associated with the client request are added to a text, log, or other suitable file. If previous information is already stored in the server-side active bookmark file, the additional information can be concatenated to the end of the respective file. If the active bookmark file is represented by a particular script, instructions associated with changing the state of the server application are added to the script. In some instances, only information necessary to change the state of the server application is included in the server-side active bookmark, while in others, all information associated with the client request, including information not directly relevant to the change in server application state, may be included in the server-side active bookmark.

After the relevant information is added to the active bookmark, the server application and/or server determines at 456 whether a notification to end the server-side active bookmark creation is received. In some instances, the notification is received from the client and/or the client application, while in others, the notification may be generated by the server application itself, as well as based on one or more other components within environment 100 (internal or external to the client and/or the server). For example, the client may send a notification from the user when a particular interaction is complete, or when a particular portion of the interaction for which an active bookmark is being created is complete. Additionally, certain events that occur during the execution of the server application may generate one or more notifications to end the active bookmark's creation. If the server and/or server application determines that no notification is received, method 430 continues at 460. If the server and/or server application determines that such a notification is received, then method 430 moves to 464.

At 460, the server application and/or server determines if an additional client request is received after the previous client request. If an additional client request is received (and no end notification is received first at 456), then method 430 returns to 444. If, however, no additional client requests are received, method 430 continues at 464. At 464, the server application, server, or other suitable component finalizes the server-side active bookmark. For instance, if a particular file is opened or used to insert additional client request information, that file is closed and prepared for storage. Additionally, if the file is an XML or other markup-type file, then the appropriate closing tags are added to signify that the server-side active bookmark is complete. Further, appropriate actions associated with a database storing the server-side active bookmark can be performed to indicate or in accordance with the completion of the server-side active bookmark. Still further, if active bookmarks are stored as scripts, the closing commands or operations associated with a server-side bookmark are added.

Once the server-side active bookmark is finalized, the server application, server, or other suitable component stores the associated active bookmark file at 468. In some instances, the server-side active bookmark may be stored at the server and associated with a particular URL or other identifier allowing clients to send requests for replay of the server-side active bookmark at 472. In those instances, the active bookmark may be stored and linked to or associated with a particular database entry providing the URL redirection services needed to allow for direct linking to the server-side active bookmark. In other instances, the server-side bookmark is stored in any suitable manner so that clients may access the server-side bookmark using a particular URL or a generic URL with one or more parameters associated with the server-side active bookmark. At 476, the server application returns, or sends, a URL associated with the active bookmark to the client application. In some instances, the URL sent to the client application can be specific to the server application such that only a client application associated with the specific server application can execute the active bookmark. In other instances, any client application, such as a generic web browser, will be able to access the server-side active bookmark by calling the URL associated with the generated active bookmark. Once completed, method 430 continues at 480 where the server application performs its normal operations.

FIG. 5A is a flowchart illustrating one particular implementation of a computer implemented method or process 500 for using a server-side active bookmark from the client's perspective. This particular illustration is associated with method 400 of FIG. 4A, in that the client of FIG. 4A is interacting with the server of FIG. 4B. Similar to FIG. 4A, method 500 is generally described in the context of environment 100. It will be understood that method 500 may be performed by alternative systems and environments, as well as in connection with different methods than as described, where appropriate.

At 502, the client and/or client application activates a server-side active bookmark link, or a link associated with the server-side active bookmark at the server. In some examples, the link may be a specific URL propagated by the server application after the server-side bookmark's creation. The URL may be activated by the client associated with the active bookmark's generation, as well as another client not associated with the active bookmark's generation. For example, because the server-side active bookmark may be defined by a specific URL, that URL may be sent among one or more clients such that various users and clients can access or replay the results of the same client/server application interactions as those performed during the active bookmark's creation.

At 504, the client determines whether the client application is initialized. If the client application is not initialized, method 500 continues at 506 and initializes the client application. If the client application is initialized, method 500 continues at 508, where the URL associated with the active bookmark is sent to the server. It should be noted that in some instances, the communication sent from the client to the server may not be a URL, but instead some other suitable type of communication between the client application and the server and/or the server application. In any event, the communication sent at 508 is meant to indicate to the server and/or server application that a particular server-side active bookmark is to be activated.

At 510, the client application determines whether the various steps associated with the server-side active bookmark are to be presented or displayed at the client. In most instances, the steps associated with the active bookmark will only be executed at the server without showing the intermediate screens or actions to the user. In this manner, the URL associated with the server-side active bookmark is virtually identical to the user, client, and client application, in that only a single screen is provided after activation of the server-side active bookmark link. However, in some instances, such as those associated with a helpdesk request or other information technology troubleshooting or assistance, the entire set of interactions may be relevant to use of the active bookmark. In those cases, at 512 the client application and/or the client presents the execution of the various steps associated with the active bookmark to the user, such as at a client's GUI. If the intermediate steps of the active bookmark are not to be shown, method 500 continues at 514.

At 514, the client application presents the final, or target, page/screen associated with the server-side active bookmark. In other words, the final location included in the creation of the server-side active bookmark is presented. In this manner, the active bookmark URL acts similar to a traditional bookmark, providing a single page associated with a defined URL. Once the target screen is presented, method 500 continues at 516, where normal client application operations can be performed.

FIG. 5B is a flowchart illustrating a particular implementation of a computer implemented method or process 530 for using a server-side active bookmark from the server's perspective. This particular illustration is associated with method 400 of FIG. 4A and method 430 of FIG. 4B, in that the server-side active bookmark used in method 530 was created using methods 400 and 430, as well as method 400 of FIG. 4A describing the client-side perspective of using the server-side active bookmark. Although associated with these other methods, method 530 may be used with any appropriate server-side active bookmark, including those generated by methods or processes other than those described in FIG. 4A, as well as another method for using the client-side active bookmark at the client.

At 534, the server and/or server application receives a request from the client application associated with a particular URL. The request may be for any URL associated with the server application, including those not associated with a server-side active bookmark. At 538, the server determines whether or not the server application is initialized. If not, the server application is initialized at 542. Once the server application is initialized, method 530 continues at 544.

At 544, the server determines whether the URL (or other message) sent from the client is associated with a server-side active bookmark. This determination may be made, for example, by reviewing the URL for a particular parameter known by the server or server application to be associated with a server-side active bookmark. In other examples, each server-side active bookmark may be associated with its own unique URL. Any other suitable method of determining whether the URL is associated with the server-side active bookmark may be used at 544. If no server-side active bookmark is associated with the URL, method 530 skips to 566, where the server application processes the request as a normal URL request and continues its normal operations. If, however, the server and/or server application determines that a server-side active bookmark is associated with the received URL, then method 530 continues at 546.

At 546, the server application (or other suitable component) may search an active bookmark list or database for the server-side active bookmark associated with the client request. In some instances, no search may be necessary, as the URL itself may be explicitly associated with a particular active bookmark. In other instances, an active bookmark parameter in the URL may need to be linked to a particular server-side active bookmark, such as by accessing an internal link located at the server. In some instances, the active bookmark may be stored external to the server, such that the server and/or server application must send a request to an external component to retrieve and perform the appropriate active bookmark.

At 550, the server application retrieves the first (or next) action associated with the retrieved bookmark. In some instances, this may include reading one or more instructions and parameters from the server-side active bookmark file. In others, this may involve executing one or more steps in an active bookmark script. At 552, the server application determines whether the currently retrieved action would result in a critical application state (similar to 350 of FIG. 3B). In some instances, the determination may also be made after or concurrently with performing the retrieved action. If the server application determines that the action would result in a critical application state, then method 530 continues at 553 where the server application sends an interrupt message to the client application. The server application's interrupt message may be a warning message notifying the user or client application that the retrieved step is associated with a critical state, such as entry to a secure file or action, or an action that should generally not be replayed, as well as any other appropriate information. In addition to, or instead of, the warning, the server application's interrupt message may instead be a message indicating that the replay of the server-side active bookmark is to be ended, or will not be continued. In the illustrated example of FIG. 5B, after sending the interrupt message, method 530 continues at 566 where the server-side active bookmark reply is ended and normal server application operations are performed. In alternative examples, the server application may determine whether the client application (and its user) have decided to continue with the bookmark replay despite the warning. In those instances, or where the current action does not result in a critical application state, method 530 continues at 554.

At 554, the retrieved action is performed by the server application. Generally, this involves executing a server application step based on one or more parameters defined in the active bookmark. Once the action is performed, the server and/or server application determines whether additional actions are included in the server-side active bookmark at 558. In some instances, this determination may be based on whether the end of an active bookmark file is reached, or whether a notice is received from the active bookmark to end the replay. If additional actions are included, method 530 returns to 550 and retrieves the next action or instructions. If no additional actions are required by or included with the active bookmark, method 530 continues at 562.

Although not illustrated in FIG. 5B, in some instances, the server application may optionally send intermediate screens to the client application during the replay. For example, if the server-side active bookmark is associated with a plurality of server application states, each state change may be sent to the client application so that an associated user can understand the progression throughout runtime. In some instances, the GUI associated with the client application may include UI elements allowing the user to select whether the intermediate screens are to be visible, and thus returned by the server application. In others, the determination can be made by an administrator or other user associated with the client application and/or the server application. For instance, the intermediate screens may be important to information technology specialists attempting to diagnose an issue with the client application and/or the server application, while a non-IT user may simply desire to see the end product of the client requests.

At 562, the server application sends the final (or target) page associated with the server-side active bookmark to the client application. In this instance, only the final product of the active bookmark is provided to the client. In some instances, each screen generated during the execution or replay of an active bookmark may be provided to the client. Whether the intermediate screens are presented to the client may be a setting associated with the server application and, in some instances, defined by an administrator. Once the final page is provided to the client, the server application performs its normal operations at 566.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures does not necessarily require the particular order shown, or sequential order, to achieve the desired results. In certain implementations, multitasking and parallel processing may be advantageous. Other variations are within the scope of the following claims.

1-12. (canceled)

13. A computer-implemented method for creating a server-side active bookmark, the method steps performed by a processor and comprising:
receiving a notification to initiate creation of a server-side active bookmark at a server;
after receiving the notification, recording a set of information defining at least one client request associated with a server application in a server-side active bookmark file at the server, the set of recorded information capable of being replayed to display a final state of the server application; and
associating the server-side active bookmark file with a specific uniform resource locator (URL) addressable by a plurality of clients.

14. The computer-implemented method of claim 13, wherein the final state of the server application comprises a final screen associated with the recorded client requests to the server application.

15. The computer-implemented method of claim 13 further comprising:
receiving a request from one of the plurality of clients for the specific URL associated with the server-side active bookmark;
in response to the received request, executing the set of recorded information to replay the at least one client request; and
presenting the final state of the server application associated with the server-side active bookmark file to the requesting client.

16. The computer-implemented method of claim 15 further comprising presenting at least one intermediate state of the server application associated with the server-side active bookmark file to the requesting client.

17. The computer-implemented method of claim 15, wherein only the final state of the server application associated with the server-side active bookmark file is presented to the requesting client.

18. The computer-implemented method of claim 13, wherein associating the server-side active bookmark file with a specific URL comprises defining a unique URL linked to the server-side active bookmark file.

19. The computer-implemented method of claim 13, wherein associating the server-side active bookmark file with a specific URL comprises defining a parameter within a predefined URL linking the predefined URL to the server-side active bookmark.

20. The computer-implemented method of claim 13, wherein associating the server-side active bookmark file with a specific URL addressable by a plurality of clients comprises linking a database field storing the recorded set of information with the specific URL.

21. A computer program product encoded on a non-transitory, tangible storage medium, the product comprising computer readable instructions for causing one or more processors to perform operations comprising:
receiving a notification to initiate creation of a server-side active bookmark at a server;
after receiving the notification, recording a set of information defining at least one client request associated with a server application in a server-side active bookmark file at the server, the set of recorded information capable of being replayed to display a final state of the server application; and
associating the server-side active bookmark file with a specific uniform resource locator (URL) addressable by a plurality of clients.

22. The computer program product of claim 21, wherein the final state of the server application comprises a final screen associated with the recorded client requests to the server application.

23. The computer program product of claim 21 further comprising:
receiving a request from one of the plurality of clients for the specific URL associated with the server-side active bookmark;
in response to the received request, executing the set of recorded information to replay the at least one client request; and
presenting the final state of the server application associated with the server-side active bookmark file to the requesting client.

24. The computer program product of claim 23 further comprising presenting at least one intermediate state of the server application associated with the server-side active bookmark file to the requesting client.

25. The computer program product of claim 23, wherein only the final state of the server application associated with the server-side active bookmark file is presented to the requesting client.

26. The computer program product of claim 21, wherein associating the server-side active bookmark file with a specific URL comprises defining a unique URL linked to the server-side active bookmark file.

27. The computer program product of claim 21, wherein associating the server-side active bookmark file with a specific URL comprises defining a parameter within a predefined URL linking the predefined URL to the server-side active bookmark.

28. The computer program product of claim 21, wherein associating the server-side active bookmark file with a specific URL addressable by a plurality of clients comprises linking a database field storing the recorded set of information with the specific URL.

29. A system comprising:
memory for storing at least one server-side active bookmark; and
at least one processor operable to:
receive a notification to initiate creation of a server-side active bookmark at a server;
after receiving the notification, record a set of information defining at least one client request associated with a server application in a server-side active bookmark file at the server, the set of recorded information capable of being replayed to display a final state of the server application; and
associate the server-side active bookmark file with a specific uniform resource locator (URL) addressable by a plurality of clients.

30. The system of claim 29, wherein the final state of the server application comprises a final screen associated with the recorded client requests to the server application.

31. The system of claim 29, the at least one processor further operable to:
receive a request from one of the plurality of clients for the specific URL associated with the server-side active bookmark;
in response to the received request, execute the set of recorded information to replay the at least one client request; and
present the final state of the server application associated with the server-side active bookmark file to the requesting client.

32. The system of claim 31, the at least one processor further operable to present at least one intermediate state of the server application associated with the server-side active bookmark file to the requesting client.
